(19) United States
(12) Patent Application Publication
(10) Pub. No.: US 2026/0057584 A1
(43) Pub. Date: Feb. 26, 2026

(54) IMAGE EDITING METHOD, APPARATUS, ELECTRONIC DEVICE AND STORAGE MEDIUM

(71) Applicant: Beijing Zitiao Network Technology Co., Ltd., Beijing (CN)

(72) Inventors: Bo Liu, Beijing (CN); Shuai Li, Beijing (CN); Xinghua Zhang, Beijing (CN)

(21) Appl. No.: 19/304,785

(22) Filed: Aug. 20, 2025

(30) Foreign Application Priority Data
Aug. 21, 2024 (CN) 202411155443.8

(51) Int. Cl. G06T 11/60; G06T 3/40

(52) U.S. Cl. CPC G06T 11/60; G06T 3/40; G06T 2210/22

(57) ABSTRACT

The disclosed embodiments provide an image editing method, apparatus, electronic device and storage medium, which obtains a collage template and corresponding filling images, wherein the collage template represents the layout of at least two collage canvases, and the collage canvases are used to carry the corresponding filling image; obtains canvas compression coefficients of the collage canvases based on the image resolutions of the filling images and the canvas resolutions of the corresponding collage canvases, and the canvas compression coefficients representing the resolution compression ratios of the collage canvases; obtains the derived resolution of the collage template according to the canvas compression coefficients of the collage canvases, and generates a collage image based on the derived resolution.

### CROSS-REFERENCE TO RELATED APPLICATION(S)

This application claims priority to Chinese Application No. 202411155443.8 filed on Aug. 21, 2024, the disclosure of which is incorporated herein by reference in its entirety.

### FIELD

The embodiments of the present disclosure relate to the field of image processing technology, and in particular to an image editing method, apparatus, electronic device, and storage medium.

### BACKGROUND

Currently, using the collage template in the video editing application (Application, APP), multiple pictures can be spliced into a collage image according to a certain layout, thereby realizing personalized multi-picture design and display, which is often used in video production scenarios to generate video covers, video illustrations, etc.

In the prior art, in order to control the computational resource overhead of the generated collage image, a fixed resolution is usually set for the collage template, and the collage image is generated based on the resolution.

### SUMMARY

In a first aspect, an embodiment of the present disclosure provides an image editing method, comprising:
obtaining a collage template and corresponding filling images, wherein the collage template represents a layout of at least two collage canvases, and the collage canvases are used to carry the corresponding filling images; obtaining canvas compression coefficients of the collage canvases based on image resolutions of the filling images and canvas resolutions of the corresponding collage canvases, and the canvas compression coefficients representing resolution compression ratios of the collage canvases; obtaining derived resolution of the collage template based on the canvas compression coefficients of the collage canvases, and generating a collage image based on the derived resolution, wherein the derived resolution is less than or equal to the maximum resolution.

In a second aspect, an embodiment of the present disclosure provides an image editing apparatus, comprising:
an obtaining module, configured to obtain a collage template and corresponding filling images, wherein the collage template represents a layout of at least two collage canvases, and the collage canvases are used to carry the corresponding filling images;
a processing module, configured to obtain canvas compression coefficients of the collage canvases based on image resolutions of the filling images and canvas resolutions of the corresponding collage canvases, the canvas compression coefficients representing resolution compression ratios of the collage canvases; and
an output module, configured to obtain derived resolution of the collage template based on canvas compression coefficients of the collage canvases, and generate a collage image based on the derived resolution, wherein the derived resolution is less than or equal to the maximum resolution.

In a third aspect, an embodiment of the present disclosure provides an electronic device, including: a processor and a memory, wherein:
the memory stores computer-executable instructions;
the processor executes the computer-executable instructions stored in the memory, causing the at least one processor executes the image editing method as described in the first aspect and the possible design of the first aspect above.

In a fourth aspect, an embodiment of the present disclosure provides a computer-readable storage medium, in which computer execution instructions are stored, and the computer execution instructions, when executed by a processor, implement the image editing method described in the first aspect and the possible design of the first aspect.

In a fifth aspect, an embodiment of the present disclosure provides a computer program product, including a computer program, which, when executed by a processor, implements the image editing method described in the first aspect and the possible design of the first aspect.

### BRIEF DESCRIPTION OF THE DRAWINGS

In order to more clearly illustrate the embodiments of the present disclosure or the technical solutions in the prior art, the drawings required for use in the embodiments or the description of the prior art will be briefly introduced below. Obviously, the drawings described below are some embodiments of the present disclosure. For ordinary technicians in this field, other drawings can be obtained based on these drawings without paying creative labor.

FIG. 1 is a diagram of an application scenario of the image editing method provided by an embodiment of the present disclosure;

FIG. 2 is a flow chart diagram 1 of an image editing method provided by an embodiment of the present disclosure;

FIG. 3 is a flow chart of a specific implementation method of step S102 in the embodiment shown in FIG. 2;

FIG. 4 is a schematic diagram of a process for determining a canvas weight provided by an embodiment of the present disclosure;

FIG. 5 is a flow chart of a specific implementation method of step S1022 in the embodiment shown in FIG. 3;

FIG. 6 is a schematic diagram of the distribution of a collage canvas in a collage template provided by an embodiment of the present disclosure;

FIG. 7 is a flow chart of a specific implementation method of step S103 in the embodiment shown in FIG. 2;

FIG. 8 is a flow chart diagram 2 of the image editing method provided by the embodiment of the present disclosure;

FIG. 9 is a schematic diagram of a process for obtaining derived resolution of a picture template provided by an embodiment of the present disclosure;

FIG. 10 is a structural block diagram of an image editing apparatus provided by an embodiment of the present disclosure;

FIG. 11 is a schematic diagram of the structure of an electronic device provided by an embodiment of the present disclosure;

FIG. 12 is schematic diagram of the hardware structure of the electronic device provided by the embodiments of the present disclosure.

### DETAILED DESCRIPTION OF EMBODIMENTS

The collage images generated by the solutions in the prior art have the problems of blurred images and poor display effect.

The embodiments of the present disclosure provide an image editing method, apparatus, electronic device and storage medium to overcome the problems of blurred images and poor display effect of collage images.

In order to make the purpose, technical solution and advantages of the embodiments of the present disclosure clearer, the technical solution in the embodiments of the present disclosure will be clearly and completely described below in conjunction with the drawings in the embodiments of the present disclosure. Obviously, the described embodiments are part of the embodiments of the present disclosure, not all of the embodiments. Based on the embodiments in the present disclosure, all other embodiments obtained by ordinary technicians in this field without creative work are within the scope of protection of the present disclosure.

It should be noted that the user information (including but not limited to user device information, user personal information, etc.) and data (including but not limited to data used for analysis, stored data, displayed data, etc.) involved in this disclosure are all information and data authorized by the user or fully authorized by all parties, and the collection, use and processing of relevant data must comply with the relevant laws, regulations and standards of relevant countries and regions, and provide corresponding operation entrances for users to choose to authorize or refuse.

The application scenarios of the present disclosure are explained below:

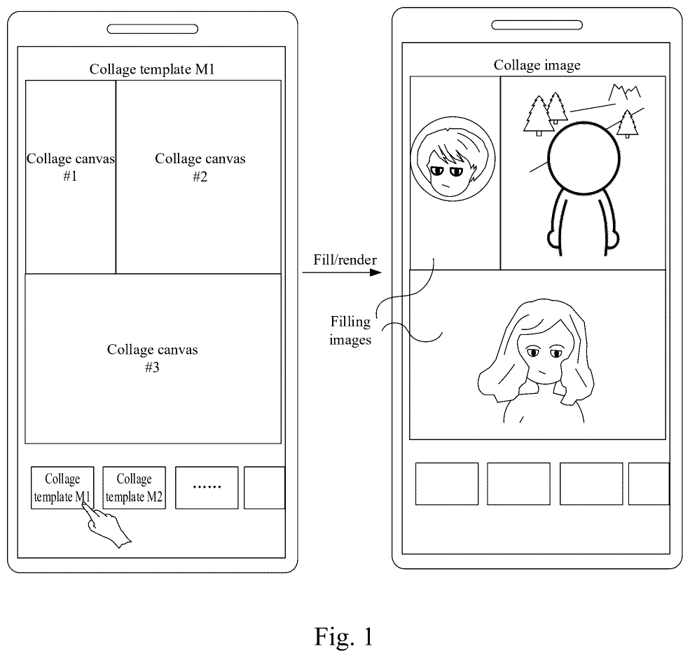

FIG. 1 is a diagram of an application scenario of the image editing method provided by the embodiment of the present disclosure. The image editing method provided by the embodiment of the present disclosure can be applied to an application (APP, Application) with a collage function, such as a video editing application, a short video application, etc. More specifically, it can be applied to an application scenario in which a collage image is generated based on a collage template. The execution subject of this embodiment can be terminal devices running the above-mentioned applications with a collage function, or a server deploying the service ends corresponding to the above-mentioned applications, or other electronic devices that perform similar functions.

Among them, in some embodiments, the terminal device or server can implement the image editing method provided in the embodiment of the present application by running various computer executable instructions or computer programs. For example, the computer executable instructions can be program-level commands, machine instructions or software instructions. The computer program can be a native program or software module in the operating system; it can be a local application, that is, a program that needs to be installed in the operating system to run, or it can be a small program embedded in any APP, that is, a program that runs based on a browser environment. In summary, the above-mentioned computer executable instructions can be instructions in any form, and the above-mentioned computer programs can be an application, module or plug-ins in any form, and the specific implementation form can be configured as needed. Further, in some embodiments, the server can be an independent physical server, or a server cluster or distributed system composed of multiple physical servers, or a cloud server that provides cloud services, cloud storage, cloud communication, cloud database, cloud computing, cloud functions, network services, middleware services, domain name services, security services, content delivery networks (Content Delivery Network, CDN), and basic cloud computing services such as big data and artificial intelligence platforms, wherein the cloud service can be an interactive processing service for terminal devices to call.

As shown in FIG. 1, taking a terminal device as an example, after running a video editing application, in response to user operations, a collage template M1 is loaded from the collage templates to be selected provided by the application (such as collage template M1, collage template M2, etc. shown in the figure), and the collage template M1 includes multiple collage canvases, such as collage canvas #1, collage canvas #2, and collage canvas #3 shown in the figure. Afterwards, in response to the user's image loading operation, corresponding filling images are filled in the above collage canvas #1, collage canvas #2, and collage canvas #3, respectively, and then, based on the size and layout of the above collage canvases, the filling images are rendered as a whole to generate collage images, thereby realizing the collage function of multiple frames of images.

In the prior art, in the process of generating a collage image based on a collage template, in order to avoid taking up too much computing resources, resulting in problems such as terminal operation lag and excessive server load, the system usually limits the derived resolution of the final derived collage image. At the same time, the filling images selected by the user usually have different image resolutions. In this case, when setting the image resolution of the collage image in the prior art, the minimum resolution of each filling image is usually used as the derived resolution of the collage image. However, in the above-mentioned scheme in the prior art, when the minimum resolution of each filling image is used as the derived resolution of the collage image, other filling images will be over-compressed, thereby affecting the clarity and display effect of the generated collage image.

Embodiments of the present disclosure provides an image editing method to solve the above-mentioned problem.

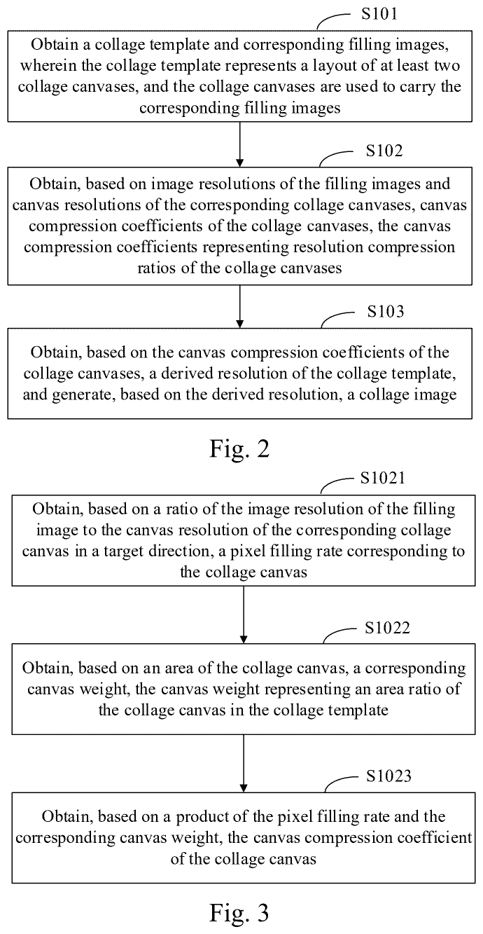

Referring to FIG. 2, FIG. 2 is a flow chart diagram 1 of an image editing method provided by an embodiment of the present disclosure. The method of this embodiment can be applied in a terminal device, and the image editing method comprises the following steps.
Step S101: a collage template and corresponding filling images are obtained, wherein the collage template represents the layout of at least two collage canvases, and the collage canvases are used to carry the corresponding filling images.

Exemplarily, referring to the schematic diagram of the application scenario shown in FIG. 1, this embodiment is described by taking the case where the terminal device is executed as an example. Specifically, after the terminal device runs the above-mentioned application with a collage function (such as a video editing application, hereinafter referred to as the application), the collage function can be provided to the user by means of a function control. After that, the user triggers the function control by operating the application, and selects the corresponding collage template, and adds a filling image to each collage canvas in the collage template. The above process and the process in which the terminal device obtains the collage template and the corresponding filling images. Among them, there are many user operation methods to implement the above process, for example, by clicking the collage function control, a plurality of collage templates to be selected are displayed, and each collage template represents a collage layout composed of more than two collage canvases, wherein the collage layout is information describing the canvas size of at least two collage canvases, and the positional relationship between the canvases. The canvas is used to carry the corresponding filling image, realize the control of the image size and position of the filling image, and finally realize the purpose of controlling the layout style of the collage image. The above-mentioned collage canvas has different implementation methods under different operating systems and drawing components, but the concept is the existing technology known to those skilled in the art and will not be described in detail here.
Step S102: canvas compression coefficients of the collage canvases are obtained based on the image resolutions of the filling images and the canvas resolutions of the corresponding collage canvases, the canvas compression coefficients representing resolution compression ratios of the collage canvases.

Exemplarily, after the terminal device obtains the collage template and the corresponding filling images, first, the maximum resolution corresponding to the collage template and the image resolution of each filling image are obtained, wherein the sum of the canvas resolutions of the collage canvases is the maximum resolution of the collage template. Exemplarily, the maximum resolution is the maximum size, which is represented by two values, the horizontal size and the vertical size, such as 2048*1024. The maximum resolution corresponding to the collage template is the size restriction condition for the collage image finally generated, so that its horizontal size and vertical size do not exceed the corresponding values. For example, based on the above example, the maximum horizontal size of the collage image is 2048 and the maximum vertical size is 1024. The canvas resolution (size) of the collage canvas is the result of splitting the maximum resolution. Taking the horizontal size as an example, the maximum horizontal size corresponding to the maximum resolution is 2048. Then, for example, the horizontal sizes of the two collage canvases can be 512 and 1536, respectively. The situation of the vertical size is similar and will not be repeated. The specific value of the canvas resolution of the collage canvas is a description of the layout of the collage canvas in the collage template.

Among them, the maximum resolution corresponding to the collage template can further be a parameter value at the system level, that is, all collage templates correspond to a fixed maximum resolution, such as 2048*1024. The maximum resolution corresponding to the collage template can also be a parameter value at the template level, that is, each collage template corresponds to a unique maximum resolution, for example, collage template mod_1, the corresponding maximum resolution is 2048*1024; collage template mod_2, the corresponding maximum resolution is 4096*1024. The maximum resolution corresponding to the collage template can be recorded in a preloaded configuration file, and the specific implementation method can be set as needed. Afterwards, based on the coordinate information representing the layout style of each collage canvas, such as the segmentation point, segmentation coordinates, and segmentation ratio coefficient recorded in the collage template, the canvas resolution of each collage canvas is determined. Among them, on the other hand, the image resolution of the filling image, that is, the resolution of the filling image itself, that is, the size of the pixel matrix constituting the filling image, after the corresponding filling image is loaded in response to the user's selection operation, the terminal device can obtain the image resolution corresponding to the filling image.

Afterwards, the terminal device obtains the corresponding canvas compression coefficient according to the image resolution of each filling image and the canvas resolution of the corresponding collage canvas, for example, according to the ratio of the image resolution to the maximum resolution in the horizontal direction. The canvas compression coefficient represents the resolution compression ratio of the collage canvas. Therefore, when the image resolution is greater than or equal to the maximum resolution in the target direction, the corresponding resolution compression ratio is greater than or equal to 1, that is, the filling image needs to be compressed; and when the image resolution is less than the maximum resolution in the target direction, the corresponding resolution compression ratio is less than 1. At this time, the filling image may need to be compressed or enlarged. The canvas compression coefficient represents the resolution compression ratio of the collage canvas, that is, the degree to which the resolution of the filling image carried by the collage canvas is compressed. Since different filling images have different resolutions, they are given a matching compression ratio, so that the final derived resolution can take both into account and avoid the problem of too small resolution.

In a possible implementation, as shown in FIG. 3, a specific implementation of step S102 comprises the following steps.
Step S1021: a pixel filling rate corresponding to the collage canvas is obtained based on a ratio of an image resolution of the filling image to a canvas resolution of the corresponding collage canvas in a target direction.
Step S1022: a corresponding canvas weight is obtained based on the area of the collage canvas, the canvas weight representing the area ratio of the collage canvas in the collage template.
Step S1023: a canvas compression coefficient of the collage canvas is obtained based on the product of the pixel filling rate and the corresponding canvas weight.

Exemplarily, as shown in FIG. 3, first, based on the ratio of the image resolution of each filling image to the canvas resolution of the corresponding collage canvas in the target direction, the corresponding pixel filling rate is obtained. The calculation steps have been introduced in the previous part and will not be repeated here. The pixel filling rate obtained in this step can represent the compressible/interpolation multiple of the filling image. Usually, the image resolution of the filling image will be greater than the maximum resolution. Therefore, the ratio of the image resolution of the filling image to the maximum resolution, that is, the pixel filling rate, is a value greater than 1.

In a possible implementation, after step S101, this embodiment further comprises the following steps.
Step S102A: in response to the first operation instruction, at least one scaling factor of the collage canvas is obtained, the scaling factor representing a scaling ratio of the filling image in the collage canvas.

Exemplarily, in a possible implementation, after loading the collage template and the corresponding filling image, the terminal device can adjust the display size of the filling image set in the collage canvas by responding to the first operation instruction input by the user, wherein the first operation instruction has multiple implementations, for example, for a mobile terminal, the first operation instruction is, for example, an instruction generated by the operation of “sliding two fingers toward each other”, thereby changing the display size of the filling image, that is, “zooming in” or “zooming out” it. After the display size of the filling image is changed, the corresponding scaling factor is obtained based on the specific value contained in the first operation instruction, such as the sliding length, and the scaling factor represents the scaling ratio of the filling image in the collage canvas, that is, the multiple of enlargement or reduction. Among them, the scaling factor can be the overall scaling multiple for the filling image set in the collage canvas, or it can be the horizontal or vertical zoom multiple for the filling image, which can be set as needed.

Accordingly, the specific implementation of step S1021 comprises the following steps.
Step S1021A: an actual image resolution of at least one filling image is obtained based on the scaling factor of the collage canvas and the image resolution of the corresponding filling image.
Step S1021B: a corresponding pixel filling rate is obtained based on a ratio of an actual image resolution of the filling image to a canvas resolution of the corresponding collage canvas in a target direction.

Exemplarily, after scaling the display size of the filling image set in the collage canvas in response to the first operation instruction, the corresponding image resolution is equivalent to also change. For example, after the filling image is reduced, the corresponding image resolution will also decrease. Therefore, based on the above-mentioned scaling factor and the image resolution of the filling image, the actual image resolution of the corresponding filling image after scaling can be obtained. Afterwards, the corresponding pixel filling rate is obtained based on the ratio of the actual image resolution of the filling image to the canvas resolution of the corresponding collage canvas in the target direction. Among them, the calculation step of the pixel filling rate has been introduced in detail in the previous embodiment steps and will not be repeated here.

In the steps of this embodiment, by responding to the first operation instruction, the filling image set in the collage canvas is scaled and the corresponding scaling factor is obtained. Then, the actual image resolution of the scaled filling image is calculated by combining the scaling factor, thereby realizing the function of further modifying and adjusting the filling image after loading, thereby improving the style diversity and design flexibility of the collage image.

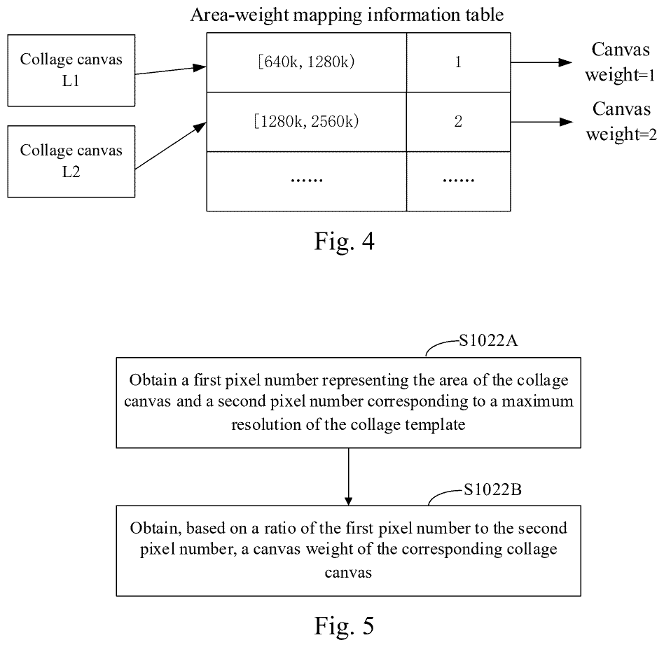

Further, exemplarily, after obtaining the pixel filling rate corresponding to each collage canvas, the area of each collage canvas is obtained, and the canvas weight is obtained based on the area of the filling image. Among them, the area of the collage canvas can be the number of pixels in the pixel matrix of the filling image, and the number of pixels can be the information recorded in the collage template. For example, if the resolution of the collage canvas is 800*800, then the corresponding pixel area can be the product of 800 and 800, that is, 640000 (which can be expressed as 640k, k is approximately expressed as 1000). In a possible implementation, different area ranges can be mapped to corresponding canvas weights based on a preset area-weight mapping information table. FIG. 4 is a schematic diagram of a process for determining canvas weights provided by an embodiment of the present disclosure. As shown in FIG. 4, based on a pre-configured area-weight mapping information table, a collage canvas with an area between [640k, 1280k), such as collage canvas L1, has a corresponding canvas weight of 1; a collage canvas with an area between [1280k, 2560k), such as filling image L2, has a corresponding canvas weight of 2, and so on. In the above manner, the canvas weight of each collage canvas in the collage template can be determined.

In another possible implementation, as shown in FIG. 5, a specific implementation of step S1022 comprises the following steps.
Step S1022A: a first pixel number representing the area of the collage canvas and a second pixel number corresponding to the maximum resolution are obtained.
Step S1022B: a canvas weight of the corresponding collage canvas is obtained based on the ratio of the first pixel number to the second pixel number.

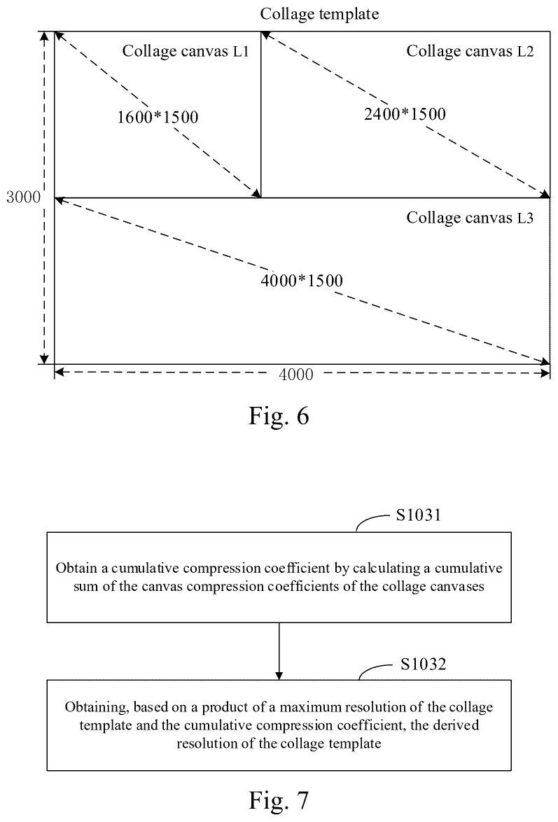

Exemplarily, for the collage canvas and the maximum resolution, the corresponding pixel number are respectively counted, that is, a plurality of first pixel numbers and a second pixel number, and then the ratio of each first pixel number to the second pixel number is respectively calculated to obtain the canvas weight of the corresponding collage canvas. FIG. 6 is a schematic diagram of the distribution of collage canvases in a collage template provided by an embodiment of the present disclosure. As shown in FIG. 6, exemplarily, the collage canvases in the collage template include collage canvas L1, collage canvas L2 and collage canvas L3, wherein the size (resolution) of collage canvas L1 is 1600*1500, and the corresponding first pixel count N1 is 2400k, that is, the area size is 2400k. Similarly, the size (resolution) of the collage canvas L2 is 2400*1500, and the corresponding first pixel number N2 is, for example, 3600k, that is, the area size is 2400k; the size (resolution) of the collage canvas L3 is 4000*1500, and the corresponding first pixel number N3 is 6000k, that is, the area size is 6000k. The maximum resolution is 4000*3000, and the corresponding second pixel number is 12000k. According to the ratio of each first pixel number to the second pixel number, the canvas weight of the collage canvas L1 is 0.2, the canvas weight of the collage canvas L2 is 0.3, and the canvas weight of the collage canvas L3 is 0.5.

Afterwards, the canvas compression coefficient is obtained based on the product of the pixel filling rate and the corresponding canvas weight. For example, the pixel filling rate of the collage canvas L1 is 1.25, the canvas weight is 0.2, and the corresponding canvas compression coefficient is 0.25.

In this embodiment, the corresponding canvas compression coefficient is obtained by respectively obtaining the area of the collage canvas and the pixel filling rate corresponding to the collage canvas. Since the influence of the area of the collage canvas and the pixel filling rate on the image display effect is taken into consideration, the obtained canvas compression coefficient can better adapt to the area size of the collage canvas and the resolution of the filling image it carries. Among them, the larger the area size of the collage canvas, the greater the influence weight, which increases the influence of the large-area collage canvas on the final determined derived resolution, so that the image in the large-area collage canvas (such as the main image in the collage image) is closer to the derived resolution of the final output collage image, thereby having a better display effect.
Step S103: the derived resolution of the collage template is obtained based on the canvas compression coefficients of the collage canvases, and a collage image is generated based on the derived resolution.

Exemplarily, after obtaining the canvas compression coefficients of each collage canvas, the canvas compression coefficients of each collage canvas are merged and then multiplied by the maximum resolution of the collage template to obtain the derived resolution of the collage template. Among them, in one possible implementation, as shown in FIG. 7, the specific implementation of step S103 comprises the following steps.
Step S1031: the cumulative compression coefficient is obtained by calculating the cumulative sum of the canvas compression coefficients of the collage canvases.
Step S1032: the derived resolution of the collage template is obtained based on the product of the maximum resolution and the cumulative compression coefficient.

Specifically, after obtaining the canvas compression coefficients of each collage canvas, the weighted sum of the canvas compression coefficients of each collage canvas is calculated, wherein the weighted coefficients between the canvas compression coefficients can be implemented in a variety of ways, for example, based on the position of the collage canvas, the corresponding position weighted coefficient is set, and when the collage canvas is located in the main position (such as the center position) in the collage template, a larger weighted coefficient is set to increase the proportion of its canvas compression coefficient in the cumulative scaling coefficient. Of course, the weighted coefficients can also be set based on other specific needs, for example, the weighted coefficients are all 1. Afterwards, the product of the canvas compression coefficients of each collage canvas and the weighted coefficients is calculated, and the cumulative compression coefficient is obtained by accumulating them. After that, the product of the cumulative compression coefficient and the maximum resolution of the collage template is calculated to obtain the ideal resolution of the collage image generated by the collage template, that is, the derived resolution. For example, the canvas compression coefficient corresponding to the collage canvas L1 is 0.25, the canvas compression coefficient corresponding to the collage canvas L2 is 0.375, and the canvas compression coefficient corresponding to the collage canvas L3 is 0.3125. The maximum resolution is 4000*3000, and the weighted coefficients are all 1. The final derived resolution is:

derived resolution=(4000*3000)*0.9375=(3750,2812)

After that, the above-mentioned filling image is rendered based on the derived resolution to generate a collage image.

In this embodiment, a collage template and corresponding filling images are obtained, wherein the collage template represents the layout of at least two collage canvases, and each collage canvas is used to carry a corresponding filling image; a canvas compression coefficient of each collage canvas is obtained based on the image resolution of each filling image and the canvas resolution of the corresponding collage canvas, and the canvas compression coefficient represents the resolution compression ratio of the collage canvas; a derived resolution of the collage template is obtained based on the canvas compression coefficient of each collage canvas, and a collage image is generated based on the derived resolution, wherein the derived resolution is less than or equal to the maximum resolution. After obtaining the collage template and the corresponding filling image, the canvas compression coefficient of each collage canvas is obtained based on the canvas resolution of the collage canvas and the image resolution of each filling image, and then the derived resolution is obtained and a collage image based on the derived resolution is generated, so that the collage image based on the derived resolution can dynamically match the image resolution of the filling image without exceeding the maximum resolution, so that its clarity reaches a high level, thereby reducing image blur and improving display effect.

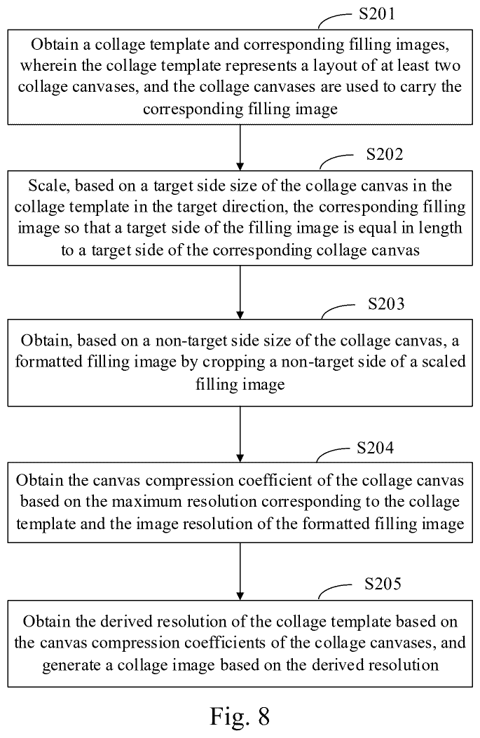

Referring to FIG. 8, FIG. 8 is a flow chart diagram 2 of the image editing method provided by the embodiment of the present disclosure. Based on the embodiment shown in FIG. 2, this embodiment further adds a step of adjusting the collage canvas and the filling image. The image editing method comprises the following steps.
Step S201: a collage template and corresponding filling images are obtained, wherein the collage template represents the layout of at least two collage canvases, and the collage canvases are used to carry the corresponding filling image.
Step S202: based on the target side size of the collage canvas in the target direction in the collage template, the corresponding filling image is scaled so that the target side of the filling image is equal in length to the target side of the corresponding collage canvas.
Step S203: based on the non-target side size of the collage canvas, the non-target side of the scaled filling image is cropped to obtain a formatted filling image.

Exemplarily, the shape of the collage canvas in the collage template is a rectangle, which has rectangular sides (edges) extending in two vertical directions, namely, long sides and short sides, or called horizontal sides and longitudinal sides, horizontal sides and vertical sides, etc. Among them, as needed, the above-mentioned sides extending in one direction can be determined as target sides, and the sides extending in another direction can be determined as non-target sides. For example, the long side of the rectangular collage canvas is determined as the target side, and the short side is determined as the non-target side; or, the horizontal side of the collage canvas is determined as the target side, and the longitudinal side is determined as the non-target side, etc. Based on the above settings, after loading the collage template and the corresponding filling image, the terminal device scales the corresponding filling image based on the target side size of each collage canvas in the collage template in the target direction, so that when the filling image is displayed in the collage canvas, it can be fully displayed in the direction corresponding to the target side. For example, based on the horizontal side of the collage canvas, the corresponding filling image is scaled so that the horizontal side of the filling image is equal to the horizontal side of the corresponding collage canvas, so that the filling image can fully display the corresponding image content in the direction of the horizontal side extension. On the other hand, based on the non-target side size of the collage canvas, such as the longitudinal side size of the collage canvas, the non-target side of the scaled filling image is cropped and/or cut to obtain a filling image that can fill the collage canvas in at least one direction, that is, a formatted filling image. After the formatted filling image is generated, since the image size of the formatted filling image has changed, and accordingly, its corresponding image resolution has also changed. In the subsequent steps, the derived resolution is calculated based on the image resolution of the changed filling image (formatted filling image), so that the derived resolution can be more accurate, enabling the filling image displayed based on the collage canvas of a specific size to have better clarity and display effect.

At the same time, it should be noted that the formatted filling image can be a new image obtained after performing actual pixel value fusion, interpolation, cropping and other processing steps on the filling image; the formatted filling image can also be the result of logical processing of the filling image, for example, the formatted filling image is a part of the filling image, and the representation of the formatted filling image is achieved through the filling image and the corresponding pixel position coordinates, which can be set specifically as needed. Optionally, after step S202, the method further comprises the following steps.
Step S202A: the scaled filling image is centered in the corresponding collage canvas.

Exemplarily, after the filling image is scaled, the target side of the scaled filling image is aligned with the target side of the collage canvas, but the non-target side may be in a non-aligned state. In this case, the filling image corresponding to the scaling can be first moved along the non-target side direction so that it is in the center of the collage canvas, that is, the scaled filling image is centered in the corresponding collage canvas. Correspondingly, after executing step S202A, the specific implementation method of step S203 comprises: based on the non-target side size of the collage canvas, symmetrically cropping the non-target sides at both ends of the scaled filling image to obtain a formatted filling image. After the scaled filling image is centered in the corresponding collage canvas, the non-target sides at both ends of the scaled filling image are cropped so that the cropped filling image is completely set in the collage canvas to obtain a formatted filling image.

In this embodiment, by centering the scaled filling image, the display effect of the filling image can be further improved, and the actual image resolution can be made more accurate, thereby improving the clarity of each filling image in the finally generated collage image.
Step S204: a canvas compression coefficient r of the collage canvas is obtained based on the maximum resolution corresponding to the collage template and the image resolution of the formatted filling image.

Exemplarily, after obtaining the image resolution of each formatted filling image, the corresponding pixel filling rate is calculated using the image resolution of each formatted filling image, and then the corresponding canvas weight is obtained based on the area of the collage canvas corresponding to each formatted filling image; and then, for example, the product of the pixel filling rate and the canvas weight can be used to obtain the canvas compression coefficient of each collage canvas. The specific process of calculating the canvas compression coefficient can refer to the process of calculating the canvas compression coefficient in the embodiment shown in FIG. 2, and will not be described in detail here.
Step S205: the derived resolution of the collage template is obtained based on the canvas compression coefficients of the collage canvases, and generating a collage image based on the derived resolution.

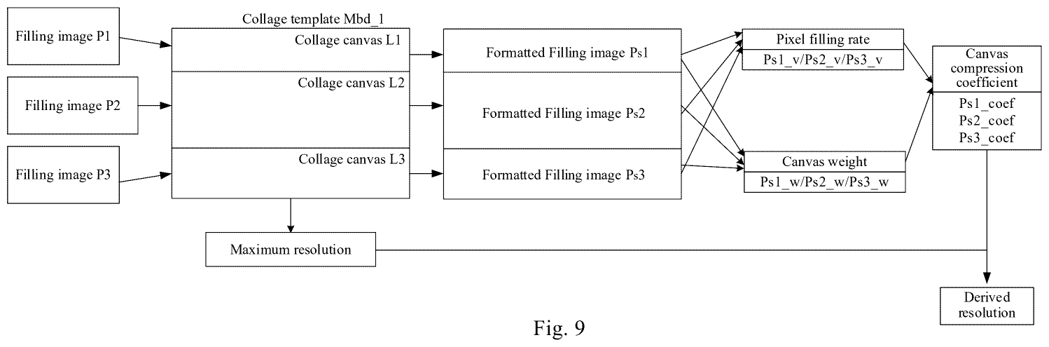

FIG. 9 is a schematic diagram of a process for obtaining derived resolution of an image template provided by an embodiment of the present disclosure. The above embodiment is described in more detail below in conjunction with FIG. 9. Referring to FIG. 9, first, the terminal device obtains a collage template Mod_1 based on a user's trigger operation. The collage template Mod_1 includes collage canvases L1, L2, and L3 having a layout style as shown in the figure, and filling images P1, P2, and P3 for filling the above collage canvases. As shown in the figure, the above collage canvases L1, L2, and L3 correspond to the filling images P1, P2, and P3 one by one. Afterwards, the terminal device stretches, crops, and centers the filling images P1, P2, and P3 based on the sizes of the collage canvases L1, L2, and L3, and obtains the corresponding formatted filling images Ps1, Ps2, and Ps3 (hereinafter referred to as Ps1, Ps2, and Ps3). After that, the pixel filling rates Ps1_v, Ps2_v and Ps3_v and canvas weights Ps1_w, Ps2_w and Ps3_w corresponding to the formatted filling images Ps1, Ps2 and Ps3 are calculated, and then the canvas compression coefficients Ps1_coef, Ps2_coef and Ps3_coef corresponding to each collage canvas are obtained based on the product of the pixel filling rate and the corresponding canvas weight. Finally, the product of the cumulative and maximum resolution of Ps1_coef, Ps2_coef and Ps3_coef is calculated to obtain the derived resolution of the collage template Mod_1.

In this embodiment, the implementation of step S201 and step S205 is the same as the implementation of step S101 and step S103 in the embodiment shown in FIG. 2 of the present disclosure, and will not be described in detail here.

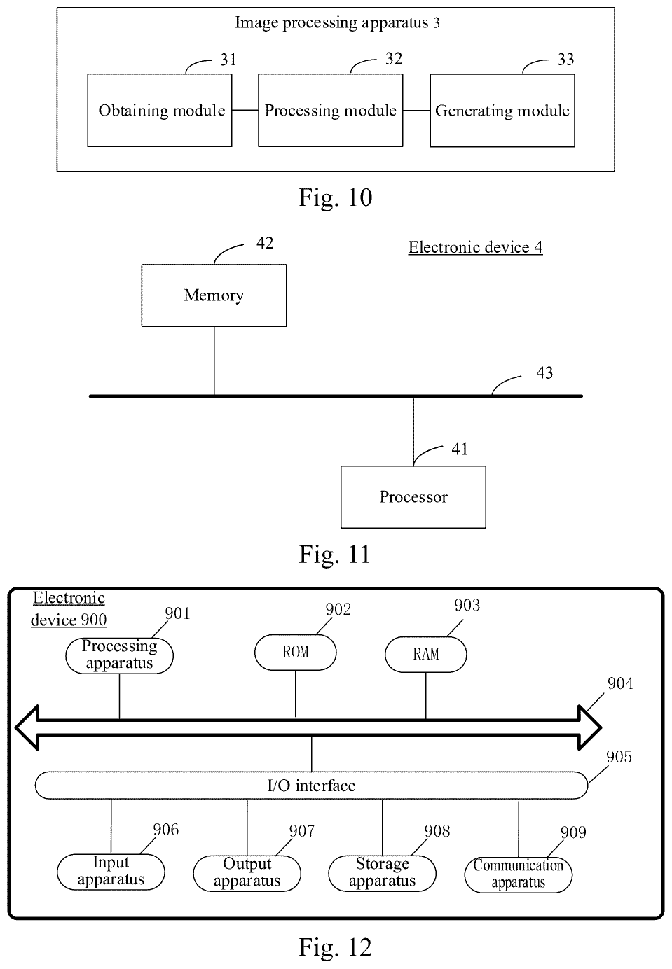

Corresponding to the image editing method of the above embodiment, FIG. 10 is a structural block diagram of the image editing apparatus provided by the embodiment of the present disclosure. The method introduced in the above embodiment can be executed by the image editing apparatus, which can be implemented by software and/or hardware, and the apparatus can be integrated in an electronic device with certain data processing functions. Among them, the electronic device can include but is not limited to mobile terminals with big data processing capabilities, as well as fixed terminals with big data processing capabilities such as desktop computers and supercomputers.

For convenience of explanation, only parts related to the embodiment of the present disclosure are shown. Referring to FIG. 10, the image editing apparatus 3 comprises:
an obtaining module 31, configured to obtain a collage template and corresponding filling images, wherein the collage template represents a layout of at least two collage canvases, and the collage canvases are used to carry the corresponding filling image;
a processing module 32, configured to obtain canvas compression coefficients of the collage canvases based on the image resolutions of the filling images and the canvas resolutions of the corresponding collage canvases, the canvas compression coefficients representing the resolution compression ratios of the collage canvases, and the sum of the canvas resolutions of the collage canvases is the maximum resolution of the collage template; and
an output module 33, configured to obtain the derived resolution of the collage template based on the canvas compression coefficients of the collage canvases, and generate the collage image based on the derived resolution, wherein the derived resolution is less than or equal to the maximum resolution.

According to one or more embodiments of the present disclosure, the processing module 32 is specifically configured to: obtain the pixel filling rate corresponding to the collage canvas based on the ratio of the image resolution of the filling image to the canvas resolution of the corresponding collage canvas in the target direction; obtain the corresponding canvas weight based on the area of the collage canvas, and the canvas weight representing the area ratio of the collage canvas in the collage template; obtain the canvas compression coefficient of the collage canvas based on the product of the pixel filling rate and the corresponding canvas weight.

According to one or more embodiments of the present disclosure, the processing module 32 is further configured to: obtain a scaling factor of at least one collage canvas in response to a first operation instruction, the scaling factor representing a scaling ratio of the filling image within the collage canvas; when the processing module 32 obtains the corresponding pixel filling rate based on the ratio of the image resolution of the filling image to the canvas resolution of the corresponding collage canvas in the target direction, it is specifically configured to: obtain the actual image resolution of at least one filling image based on the scaling factor of the collage canvas and the image resolution of the corresponding filling image; obtain the corresponding pixel filling rate based on the ratio of the actual image resolution of the filling image to the canvas resolution of the corresponding collage canvas in the target direction.

According to one or more embodiments of the present disclosure, when the processing module 32 obtains the corresponding canvas weight based on the area of the collage canvas, it is specifically configured to: obtain a first pixel number representing the area of the collage canvas, and a second pixel number corresponding to the maximum resolution; and obtain the corresponding canvas weight of the collage canvas based on the ratio of the first pixel number to the second pixel number.

According to one or more embodiments of the present disclosure, the output module 33 is specifically configured to: calculate the cumulative sum of the canvas compression coefficients of the collage canvases to obtain the cumulative compression coefficient; and obtain the derived resolution of the collage template based on the product of the maximum resolution and the cumulative compression coefficient.

According to one or more embodiments of the present disclosure, after obtaining the collage template and the corresponding filling image, the processing module 32 is further configured to: scale the corresponding filling image based on the target side size of the collage canvas in the target direction in the collage template so that the target side of the filling image is equal to the target side of the corresponding collage canvas; based on the non-target side size of the collage canvas, crop the non-target side of the scaled filling image to obtain a formatted filling image; when obtaining the canvas compression coefficient of the collage canvas based on the image resolution of the filling image and the canvas resolution of the corresponding collage canvas, the processing module 32 is specifically configured to: obtain the canvas compression coefficient of the collage canvas based on the image resolution of the formatted filling image and the canvas resolution of the corresponding collage canvas.

According to one or more embodiments of the present disclosure, before the non-target side of the scaled filling image are cropped based on the non-target side size of the collage canvas to obtain a formatted filling image, the processing module 32 is further configured to: center the scaled filling image in the corresponding collage canvas; when the processing module 32 crops the non-target side of the scaled filling image based on the non-target side size of the collage canvas to obtain a formatted filling image, the processing module 32 is specifically configured to: symmetrically crop the non-target sides at both ends of the scaled filling image based on the non-target side size of the collage canvas to obtain a formatted filling image.

Among them, the obtaining module 31, the processing module 32 and the output module 33 are connected in sequence. The image editing apparatus 3 provided in this embodiment can execute the technical solution of the above method embodiment, and its implementation principle and technical effect are similar, which will not be repeated in this embodiment.

FIG. 11 is a schematic diagram of the structure of an electronic device provided by an embodiment of the present disclosure. As shown in FIG. 11, the electronic device 4 comprises:
a processor 41, and a memory 42 communicatively connected to the processor 41, wherein:
the memory 42 stores computer-executable instructions;
the processor 41 executes the computer execution instructions stored in the memory 42 to implement the image editing method in the embodiments shown in FIG. 2 to FIG. 9.

Among them, optionally, the processor 41 and the memory 42 are connected via a bus 43.

The relevant instructions can be understood by referring to the relevant descriptions and effects corresponding to the steps in the embodiments corresponding to FIG. 2 to FIG. 9, and no further details will be given here.

An embodiment of the present disclosure provides a computer-readable storage medium, in which computer execution instructions are stored, the computer execution instructions, when executed by a processor, are configured to implement the image editing method provided in any of the embodiments corresponding to FIG. 2 to FIG. 9 of the present disclosure.

An embodiment of the present disclosure provides a computer program product, including a computer program. When the computer program is executed by a processor, the image editing method provided by any one of the embodiments corresponding to FIG. 2 to FIG. 9 of the present disclosure is implemented.

In order to implement the above embodiment, the embodiment of the present disclosure also provides an electronic device.

Referring to FIG. 12, it shows a schematic diagram of the structure of an electronic device 900 suitable for implementing an embodiment of the present disclosure, and the electronic device 900 may be a terminal device or a server. Among them, t terminal devices may include but is not limited to mobile terminals such as mobile phones, laptop computers, digital broadcast receivers, personal digital assistants (PDAs), tablet computers (Portable Android Devices, PADs), portable multimedia players (Portable Media Players, PMPs), vehicle-mounted terminals (such as vehicle-mounted navigation terminals), etc., and fixed terminals such as digital TVs, desktop computers, etc. The electronic device shown in FIG. 12 is only an example and should not impose any limitations on the functions and scope of use of the embodiments of the present disclosure.

As shown in FIG. 12, an electronic device 900 may include a processing apparatus (such as a central processing unit, a graphics processing unit, etc.) 901, which may perform various appropriate actions and processing according to a program stored in a Read Only Memory (ROM) 902 or a program loaded from a storage apparatus 908 into a Random Access Memory (RAM) 903. In the RAM 903, various programs and data required for the operation of the electronic device 900 are also stored. A processing apparatus 901, a ROM 902 and a RAM 903 are connected to each other through a bus 904. An input/output (I/O) interface 905 is also connected to the bus 904.

Typically, the following apparatus may be connected to the I/O interface 905: input apparatus 906 including, for example, a touch screen, a touchpad, a keyboard, a mouse, a camera, a microphone, an accelerometer, a gyroscope, etc.; output apparatus 907 including, for example, a liquid crystal display (LCD), a speaker, a vibrator, etc.; storage apparatus 908 including, for example, a magnetic tape, a hard disk, etc.; and communication apparatus 909. The communication apparatus 909 may allow the electronic device 900 to communicate with other devices wirelessly or by wire to exchange data. Although FIG. 12 shows an electronic device 900 with various apparatus, it should be understood that it is not required to implement or have all the apparatus shown. More or fewer apparatus may be implemented or have alternatively.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from a network through a communication apparatus 909, or installed from a storage apparatus 908, or installed from a ROM 902. When the computer program is executed by the processing apparatus 901, the above-mentioned functions defined in the method of the embodiment of the present disclosure are executed.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, device or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, device or device. In the present disclosure, a computer-readable signal medium may include a data signal propagated in a baseband or as part of a carrier wave, which carries a computer-readable program code. This propagated data signal may take a variety of forms, including but not limited to an electromagnetic signal, an optical signal, or any suitable combination of the above. Computer readable signal media may also be any computer readable medium other than computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The above computer-readable medium may be included in the electronic device, or may exist independently without being installed in the electronic device.

The computer-readable medium carries one or more programs. When the one or more programs are executed by the electronic device, the electronic device executes the method shown in the above embodiment.

Computer program code for performing the operations of the present disclosure may be written in one or more programming languages or a combination thereof, including object-oriented programming languages such as Java, Smalltalk, C++, and conventional procedural programming languages such as “C” or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer through any type of network, including a Local Area Network (LAN) or a Wide Area Network (WAN), or may be connected to an external computer (e.g., through the Internet using an Internet service provider).

The flow chart and block diagram in the accompanying drawings illustrate the possible architecture, function and operation of the system, method and computer program product according to various embodiments of the present disclosure. In this regard, each square box in the flow chart or block diagram can represent a module, a program segment or a part of a code, and the module, the program segment or a part of the code contains one or more executable instructions for realizing the specified logical function. It should also be noted that in some implementations as replacements, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The units or modules involved in the embodiments described in the present disclosure may be implemented by software or hardware, wherein the name of a unit or module does not, in some cases, constitute a limitation on the unit itself.

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), systems on chips (SOCs), complex programmable logic devices (CPLDs), and the like.

In the context of the present disclosure, a machine-readable medium may be a tangible medium that may contain or store a program for use by or in conjunction with an instruction execution system, device, or equipment. A machine-readable medium may be a machine-readable signal medium or a machine-readable storage medium. A machine-readable medium may include, but is not limited to, an electronic, magnetic, optical, electromagnetic, infrared, or semiconductor system, device, or device, or any suitable combination of the foregoing. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

In a first aspect, according to one or more embodiments of the present disclosure, there is provided an image editing method, comprising:
obtaining a collage template and the corresponding filling images, wherein the collage template represents a layout of at least two collage canvases, and the collage canvases are used to carry the corresponding filling images; obtaining canvas compression coefficients of the collage canvases based on image resolutions of the filling images and canvas resolutions of the corresponding collage canvases, the canvas compression coefficient representing a resolution compression ratio of the collage canvas, and the sum of the canvas resolutions of the collage canvases being the maximum resolution of the collage template; obtaining the derived resolution of the collage template based on the canvas compression coefficients of the collage canvases, and generating a collage image based on the derived resolution, wherein the derived resolution is less than or equal to the maximum resolution.

According to one or more embodiments of the present disclosure, obtaining a canvas compression coefficient of the collage canvas based on an image resolution of the filling image and a canvas resolution of the corresponding collage canvas comprises: obtaining a pixel filling rate corresponding to the collage canvas based on a ratio of the image resolution of the filling image to the canvas resolution of the corresponding collage canvas in a target direction; obtaining a corresponding canvas weight based on an area of the collage canvas, the canvas weight representing an area ratio of the collage canvas in the collage template; and obtaining a canvas compression coefficient of the collage canvas based on the product of the pixel filling rate and the corresponding canvas weight.

According to one or more embodiments of the present disclosure, it also comprises: in response to a first operation instruction, obtaining a scaling factor of at least one collage canvas, the scaling factor representing the scaling ratio of the filling image within the collage canvas; obtaining a corresponding pixel filling rate based on a ratio of an image resolution of the filling image to a canvas resolution of the corresponding collage canvas in a target direction, comprising: obtaining an actual image resolution of at least one filling image based on the scaling factor of the collage canvas and the image resolution of the corresponding filling image; obtaining a corresponding pixel filling rate based on a ratio of the actual image resolution of the filling image to the canvas resolution of the corresponding collage canvas in a target direction.

According to one or more embodiments of the present disclosure, obtaining a corresponding canvas weight based on the area of the collage canvas comprises: obtaining a first pixel number representing the area of the collage canvas and a second pixel number corresponding to the maximum resolution; and obtaining a canvas weight of the corresponding collage canvas based on a ratio of the first number of pixels to the second number of pixels.

According to one or more embodiments of the present disclosure, obtaining the derived resolution of the collage template based on the canvas compression coefficients of the collage canvases comprises: calculating the cumulative sum of the canvas compression coefficients of the collage canvases to obtain the cumulative compression coefficient; and obtaining the derived resolution of the collage template based on the product of the maximum resolution and the cumulative compression coefficient.

According to one or more embodiments of the present disclosure, after obtaining the collage template and the corresponding filling image, it also comprises: based on the target side size of the collage canvas in the target direction in the collage template, scaling the corresponding filling image so that the target side of the filling image is equal to the target side of the corresponding collage canvas; based on the non-target side size of the collage canvas, cropping the non-target side of the scaled filling image to obtain a formatted filling image; obtaining the canvas compression coefficient of the collage canvas based on the image resolution of the filling image and the canvas resolution of the corresponding collage canvas, comprising: obtaining the canvas compression coefficient of the collage canvas based on the image resolution of the formatted filling image and the canvas resolution of the corresponding collage canvas.

According to one or more embodiments of the present disclosure, before the non-target side of the scaled filling image is cropped based on the non-target side size of the collage canvas to obtain the formatted filling image, the method further comprises: centering the scaled filling image in the corresponding collage canvas; the cropping of the non-target side of the scaled filling image based on the non-target side size of the collage canvas to obtain the formatted filling image comprising: symmetrically cropping the non-target sides at both ends of the scaled filling image based on the non-target side size of the collage canvas to obtain the formatted filling image.

In a second aspect, according to one or more embodiments of the present disclosure, there is provided an image editing apparatus, comprising:
an obtaining module, configured to obtain a collage template and corresponding filling images, wherein the collage template represents a layout of at least two collage canvases, and the collage canvases are used to carry the corresponding filling image;
a processing module, configured to obtain canvas compression coefficients of the collage canvases based on image resolutions of the filling images and canvas resolutions of the corresponding collage canvases, the canvas compression coefficients representing resolution compression ratios of the collage canvases, and the sum of the canvas resolutions of the collage canvases being the maximum resolution of the collage template;
an output module, configured to obtain derived resolution of the collage template based on canvas compression coefficients of the collage canvases, and generate a collage image based on the derived resolution, wherein the derived resolution is less than or equal to the maximum resolution.

According to one or more embodiments of the present disclosure, the processing module is specifically configured to: obtain a pixel filling rate corresponding to the collage canvas based on a ratio of an image resolution of the filling image to a canvas resolution of the corresponding collage canvas in a target direction; obtain a corresponding canvas weight based on an area of the collage canvas, the canvas weight representing an area ratio of the collage canvas in the collage template; and obtain a canvas compression coefficient of the collage canvas based on the product of the pixel filling rate and the corresponding canvas weight.

According to one or more embodiments of the present disclosure, the processing module is further configured to: obtain a scaling factor of at least one collage canvas in response to a first operation instruction, the scaling factor representing a scaling ratio of the filling image within the collage canvas; when the processing module obtains the corresponding pixel filling rate based on the ratio of the image resolution of the filling image to the canvas resolution of the corresponding collage canvas in a target direction, the processing module is specifically configured to: obtain an actual image resolution of at least one filling image based on the scaling factor of the collage canvas and the image resolution of the corresponding filling image; and obtain the corresponding pixel filling rate based on the ratio of the actual image resolution of the filling image to the canvas resolution of the corresponding collage canvas in the target direction.

According to one or more embodiments of the present disclosure, when the processing module obtains the corresponding canvas weight based on the area of the collage canvas, it is specifically configured to: obtain a first pixel number representing the area of the collage canvas, and a second pixel number corresponding to the maximum resolution; and obtain the corresponding canvas weight of the collage canvas based on the ratio of the first pixel number to the second pixel number.

According to one or more embodiments of the present disclosure, the output module is specifically configured to: calculate the cumulative sum of the canvas compression coefficients of the collage canvases to obtain the cumulative compression coefficient; and obtain the derived resolution of the collage template based on the product of the maximum resolution and the cumulative compression coefficient.

According to one or more embodiments of the present disclosure, after the collage template and the corresponding filling image are obtained, the processing module is further configured to: scale the corresponding filling image based on the target side size of the collage canvas in the target direction in the collage template so that the target side of the filling image is equal to the target side of the corresponding collage canvas; crop the non-target side of the scaled filling image based on the non-target side size of the collage canvas to obtain a formatted filling image; when the processing module obtains the canvas compression coefficient of the collage canvas based on the image resolution of the filling image and the canvas resolution of the corresponding collage canvas, the processing module is specifically configured to: obtain the canvas compression coefficient of the collage canvas based on the image resolution of the formatted filling image and the canvas resolution of the corresponding collage canvas.

According to one or more embodiments of the present disclosure, before the non-target side of the scaled filling image is cropped based on the non-target side size of the collage canvas to obtain the formatted filling image, the processing module is further configured to: center the scaled filling image in the corresponding collage canvas; when the processing module crops the non-target side of the scaled filling image based on the non-target side size of the collage canvas to obtain the formatted filling image, the processing module is specifically configured to: symmetrically crop the non-target sides at both ends of the scaled filling image based on the non-target side size of the collage canvas to obtain the formatted filling image.

In a third aspect, according to one or more embodiments of the present disclosure, there is provided an electronic device, comprising: at least one processor and a memory, wherein:
the memory stores computer-executable instructions; and
the at least one processor executes the computer-executable instructions stored in the memory, causing the at least one processor to perform the image editing method as described in the first aspect and various possible designs of the first aspect.

In a fourth aspect, according to one or more embodiments of the present disclosure, a computer-readable storage medium is provided, wherein the computer-readable storage medium stores computer execution instructions. When a processor executes the computer execution instructions, the image editing method described in the first aspect and various possible designs of the first aspect is implemented.

In a fifth aspect, according to one or more embodiments of the present disclosure, a computer program product is provided, including a computer program, which, when executed by a processor, implements the image editing method as described in the first aspect and various possible designs of the first aspect.

The above description is only a preferred embodiment of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, the above features are replaced with the technical features with similar functions disclosed in the present disclosure (but not limited to) by each other to form a technical solution.

In addition, although each operation is described in a specific order, this should not be understood as requiring these operations to be performed in the specific order shown or in a sequential order. Under certain circumstances, multitasking and parallel processing may be advantageous. Similarly, although some specific implementation details are included in the above discussion, these should not be interpreted as limiting the scope of the present disclosure. Some features described in the context of a separate embodiment can also be implemented in a single embodiment in combination. On the contrary, the various features described in the context of a single embodiment can also be implemented in multiple embodiments individually or in any suitable sub-combination mode.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

I/We claim:

1. An image editing method, comprising:
obtaining a collage template and corresponding filling images, wherein the collage template represents a layout of at least two collage canvases, and the collage canvases are used to carry the corresponding filling images;
obtaining, based on image resolutions of the filling images and canvas resolutions of the corresponding collage canvases, canvas compression coefficients of the collage canvases, the canvas compression coefficients representing resolution compression ratios of the collage canvases; and
obtaining, based on the canvas compression coefficients of the collage canvases, a derived resolution of the collage template, and generating, based on the derived resolution, a collage image.

2. The method according to claim 1, wherein obtaining, based on the image resolutions of the filling images and the canvas resolutions of the corresponding collage canvases, the canvas compression coefficients of the collage canvases comprises:
obtaining, based on ratios of the image resolutions of the filling images to the canvas resolutions of the corresponding collage canvases in a target direction, pixel filling rates corresponding to the collage canvases;
obtaining, based on area of the collage canvases, corresponding canvas weights, the canvas weights representing area ratios of the collage canvases in the collage template; and
obtaining, based on products of the pixel filling rates and the corresponding canvas weights, the canvas compression coefficients of the collage canvases.

3. The method according to claim 2, further comprising:
obtaining a scaling coefficient of at least one collage canvas in response to a first operation instruction, the scaling coefficient representing a scaling ratio of a filling image within a collage canvas;
obtaining, based on the ratios of the image resolutions of the filling images to the canvas resolutions of the corresponding collage canvases in the target direction, the corresponding pixel filling rate, comprising:
obtaining, based on the scaling coefficient of the collage canvas and an image resolution of the corresponding filling image, an actual image resolution of at least one filling image; and
obtaining, based on a ratio of the actual image resolution of the filling image to a canvas resolution of the corresponding collage canvas in the target direction, the corresponding pixel filling rate.

4. The method according to claim 2, wherein obtaining, based on the area of the collage canvases, the corresponding canvas weights comprises:
obtaining first pixel numbers representing the area of the collage canvases and a second pixel number corresponding to a maximum resolution of the collage template; and
obtaining, based on ratios of the first pixel numbers to the second pixel number, canvas weights of the corresponding collage canvases.

5. The method according to claim 1, wherein obtaining, based on the canvas compression coefficients of the collage canvases, the derived resolution of the collage template comprises:
obtaining a cumulative compression coefficient by calculating a cumulative sum of the canvas compression coefficients of the collage canvases; and
obtaining, based on a product of a maximum resolution of the collage template and the cumulative compression coefficient, the derived resolution of the collage template.

6. The method according to claim 1, wherein after obtaining the collage template and the corresponding filling images, further comprising:
scaling, based on a target side size of a collage canvas in the collage template in a target direction, a corresponding filling image so that a target side of the filling image is equal in length to a target side of the corresponding collage canvas; and
obtaining, based on a non-target side size of the collage canvas, a formatted filling image by cropping a non-target side of a scaled filling image; and
wherein obtaining, based on the image resolutions of the filling images and the canvas resolutions of the corresponding collage canvases, the canvas compression coefficients of the collage canvases comprises:
obtaining, based on an image resolution of the formatted filling image and a canvas resolution of the corresponding collage canvas, a canvas compression coefficient of the collage canvas.

7. The method according to claim 6, wherein before obtaining, based on the non-target side size of the collage canvas, the formatted filling image by cropping the non-target side of the scaled filling image, the method further comprises:
centering the scaled filling image in the corresponding collage canvas;
obtaining, based on the non-target side size of the collage canvas, the formatted filling image by cropping the non-target side of the scaled filling image, comprising:
obtaining, based on the non-target side size of the collage canvas, the formatted filling image by cropping non-target sides at both ends of the scaled filling image symmetrically.

8. The method according to claim 1, wherein a sum of the canvas resolutions of the collage canvases is a maximum resolution of the collage template, and the derived resolution is less than or equal to the maximum resolution.

9. An electronic device, comprising: a processor and a memory, wherein:
the memory stores computer-executable instructions; and
the processor executes the computer-executable instructions stored in the memory, causing the processor to:
obtain a collage template and corresponding filling images, wherein the collage template represents a layout of at least two collage canvases, and the collage canvases are used to carry the corresponding filling images;
obtain, based on image resolutions of the filling images and canvas resolutions of the corresponding collage canvases, canvas compression coefficients of the collage canvases, the canvas compression coefficients representing resolution compression ratios of the collage canvases; and
obtain, based on the canvas compression coefficients of the collage canvases, a derived resolution of the collage template, and generate, based on the derived resolution, a collage image.

10. The electronic device according to claim 9, wherein the computer-executable instructions causing the processor to obtain, based on the image resolutions of the filling images and the canvas resolutions of the corresponding collage canvases, the canvas compression coefficients of the collage canvases comprise instructions to:
obtain, based on ratios of the image resolutions of the filling images to the canvas resolutions of the corresponding collage canvases in a target direction, pixel filling rates corresponding to the collage canvases;
obtain, based on area of the collage canvases, corresponding canvas weights, the canvas weights representing area ratios of the collage canvases in the collage template; and
obtain, based on products of the pixel filling rates and the corresponding canvas weights, the canvas compression coefficients of the collage canvases.

11. The electronic device according to claim 10, wherein the computer-executable instructions further comprise instructions to:
obtain a scaling coefficient of at least one collage canvas in response to a first operation instruction, the scaling coefficient representing a scaling ratio of the filling image within the collage canvas;
wherein obtaining, based on a ratio of the image resolution of the filling image to the canvas resolution of the corresponding collage canvas in the target direction, the corresponding pixel filling rate, comprising:
obtaining, based on the scaling coefficient of the collage canvas and an image resolution of a corresponding filling image, an actual image resolution of at least one filling image; and
obtaining, based on a ratio of the actual image resolution of the filling image to the canvas resolution of the corresponding collage canvas in the target direction, the corresponding pixel filling rate.

12. The electronic device according to claim 10, wherein the computer-executable instructions causing the processor to obtain, based on the area of the collage canvases, the corresponding canvas weights comprise instructions to:
obtain first pixel numbers representing the area of the collage canvases and a second pixel number corresponding to a maximum resolution of the collage template; and
obtain, based on ratios of the first pixel numbers to the second pixel number, canvas weights of the corresponding collage canvases.

13. The electronic device according to claim 9, wherein the computer-executable instructions causing the processor to obtain, based on the canvas compression coefficients of the collage canvases, the derived resolution of the collage template comprise instructions to:
obtain a cumulative compression coefficient by calculating a cumulative sum of the canvas compression coefficients of the collage canvases; and
obtain, based on a product of a maximum resolution of the collage template and the cumulative compression coefficient, the derived resolution of the collage template.

14. The electronic device according to claim 9, wherein after obtaining the collage template and the corresponding filling images, the computer-executable instructions further comprise instructions to:
scale, based on a target side size of the collage canvas in the collage template in the target direction, the corresponding filling image so that a target side of the filling image is equal in length to a target side of the corresponding collage canvas; and
obtain, based on a non-target side size of the collage canvas, a formatted filling image by cropping a non-target side of a scaled filling image;
wherein obtaining, based on the image resolution of the filling image and the canvas resolution of the corresponding collage canvas, the canvas compression coefficient of the collage canvas comprising:
obtaining, based on an image resolution of the formatted filling image and the canvas resolution of the corresponding collage canvas, the canvas compression coefficient of the collage canvas.

15. The electronic device according to claim 14, wherein before obtaining, based on the non-target side size of the collage canvas, the formatted filling image by cropping the non-target side of the scaled filling image, the computer-executable instructions further comprise instructions to:
centering the scaled filling image in the corresponding collage canvas;
wherein obtaining, based on the non-target side size of the collage canvas, the formatted filling image by cropping the non-target side of the scaled filling image, comprising:
obtaining, based on the non-target side size of the collage canvas, the formatted filling image by cropping non-target sides at both ends of the scaled filling image symmetrically.

16. The electronic device according to claim 9, wherein a sum of the canvas resolutions of the collage canvases is a maximum resolution of the collage template, and the derived resolution is less than or equal to the maximum resolution.

17. A non-transitory computer-readable storage medium, wherein the computer-readable storage medium stores computer-executable instructions, and the computer-executable instructions, when executed by a processor, cause the processor to:
obtain a collage template and corresponding filling images, wherein the collage template represents a layout of at least two collage canvases, and the collage canvases are used to carry the corresponding filling images;
obtain, based on image resolutions of the filling images and canvas resolutions of the corresponding collage canvases, canvas compression coefficients of the collage canvases, the canvas compression coefficients representing resolution compression ratios of the collage canvases; and
obtain, based on the canvas compression coefficients of the collage canvases, a derived resolution of the collage template, and generate, based on the derived resolution, a collage image.

18. The storage medium according to claim 17, wherein the computer-executable instructions causing the processor to obtain, based on the image resolutions of the filling images and the canvas resolutions of the corresponding collage canvases, the canvas compression coefficients of the collage canvases comprise instructions to:
obtain, based on ratios of the image resolutions of the filling images to the canvas resolutions of the corresponding collage canvases in a target direction, pixel filling rates corresponding to the collage canvases;
obtain, based on area of the collage canvases, corresponding canvas weights, the canvas weights representing area ratios of the collage canvases in the collage template; and
obtain, based on products of the pixel filling rates and the corresponding canvas weights, the canvas compression coefficients of the collage canvases.

19. The storage medium according to claim 18, wherein the computer-executable instructions further comprise instructions to:
obtain a scaling coefficient of at least one collage canvas in response to a first operation instruction, the scaling coefficient representing a scaling ratio of the filling image within the collage canvas;
wherein obtaining, based on a ratio of the image resolution of the filling image to the canvas resolution of the corresponding collage canvas in the target direction, the corresponding pixel filling rate, comprising:
obtaining, based on the scaling coefficient of the collage canvas and an image resolution of a corresponding filling image, an actual image resolution of at least one filling image; and
obtaining, based on a ratio of the actual image resolution of the filling image to the canvas resolution of the corresponding collage canvas in the target direction, the corresponding pixel filling rate.

20. The storage medium according to claim 18, wherein the computer-executable instructions causing the processor to obtain, based on the area of the collage canvases, the corresponding canvas weights comprise instructions to:
obtain first pixel numbers representing the area of the collage canvases and a second pixel number corresponding to a maximum resolution of the collage template; and
obtain, based on ratios of the first pixel numbers to the second pixel number, canvas weights of the corresponding collage canvases.
